(19) United States
(12) Patent Application Publication
(10) Pub. No.: US 2015/0171426 A1
(43) Pub. Date: Jun. 18, 2015

(54) POROUS AMORPHOUS GeOx AND ITS APPLICATION AS AN ANODE MATERIAL IN LI-ION BATTERIES

(71) Applicant: BROOKHAVEN SCIENCE ASSOCIATES, LLC, Upton, NY (US)

(72) Inventors: Xiao-Liang Wang, Hayward, CA (US); Weiqiang Han, Ningbo (CN)

(73) Assignee: BROOKHAVEN SCIENCE ASSOCIATES, LLC, Upton, NY (US)

(21) Appl. No.: 14/358,926

(22) PCT Filed: Nov. 30, 2012
(86) PCT No.: PCT/US2012/067229

§ 371 Date: May 16, 2014

Related U.S. Application Data
(60) Provisional application No. 61/566,455, filed on Dec. 2, 2011.

(51) Int. Cl. H01M 4/48; H01M 4/62; C01G 17/00

(52) U.S. Cl. CPC H01M 4/48; C01G 17/00; H01M 4/625; H01M 4/622; H01M 2004/027

(57) ABSTRACT

Amorphus germanium oxide materials are provided that are composed of germanium and oxygen having a formula GeOₓ, where 0.01≦x≦1.99. The germanium oxide forms nanoscale hierarchical porous agglomerates that have high capacity, high diffusivity of lithium, and enhanced cycling stability. The enhanced or superior performance (structural stability and reactivity) of these materials is due to the formation of ultrafine primary nanoparticles, amorphization, pore formation, preferably of nanoscale nature, and the incorporation of oxygen. These amorphous germanium oxide materials may serve as high-capacity anode materials and afford an enhanced capacity applicable for electrochemical cells such as Li-ion batteries.

### CROSS-REFERENCE TO A RELATED APPLICATION

This application claims the benefit under 35 U.S.C. 119(e) of U.S. Provisional Application no. 61/566,455 filed on Dec. 2, 2011, the content of which is incorporated herein in its entirety.

### STATEMENT OF GOVERNMENT LICENSE RIGHTS

The present invention was made with government support under contract number DE-ACO2-98CH10886 awarded by the U.S. Department of Energy. The United States government may have certain rights in this invention.

### BACKGROUND

I. Field of the Invention

This invention relates to the field of germanium based compounds. In particular, the invention relates to an amorphous hierarchical porous germanium oxide (GeOₓ) and a method of synthesizing this compound. The invention also relates to the use of the germanium oxide compounds in making high capacity electrode(s) for Li-ion batteries.

II. Background of the Related Art

A lithium-ion battery (or Li-ion battery) belongs to a family of rechargeable battery types in which lithium ions move from the negative electrode to the positive electrode during discharge, and back when charging. Unlike lithium primary batteries (which are disposable), lithium-ion electrochemical cells use an intercalated lithium compound as the electrode material instead of metallic lithium. The three primary functional components of a lithium-ion battery are the anode, cathode, and electrolyte. The anode of a conventional lithium-ion cell is made from carbon (graphite), the cathode is a metal oxide, and the electrolyte is a lithium salt in an organic solvent. The amount of electric charge that a battery can store is referred to as battery capacity, which is usually expressed as the product of 20 hours multiplied by the maximum constant current that the battery can supply for 20 hours at 68 F.° (20 C°). Typically, more electrolyte and electrode material in the cell will result in the increase in battery's capacity. In other words, a 1 g anode made from graphite, which has a maximum theoretical specific capacity of 372 mAh/g, would have specific capacity of 372 mAh, whereas a 2 g anode made from the same material would have specific capacity of 744 mAh. The disadvantage of such approach for increasing capacity that such batteries would be prohibitively large and heavy.

Thus, there has been significant interest in the development of alternatives to conventional graphite that would have higher specific capacity without the need to increase the amount of the electrode material. For instance, some of these materials include silicon that has a specific capacity of 4,198 mAh g⁻¹, tin that has a specific capacity of ˜993 mAh g⁻¹, germanium that has a specific capacity of 1,624 mAh g⁻¹, antimony that has a specific capacity of ˜660 mAh g⁻¹, and aluminum that has a specific capacity of 2,235 mAh g⁻¹. Unfortunately, all the high capacity anode materials, suffer from the major problem of poor capacity retention due to a volume change and severe structural stress, which prevents these materials from being used in commercial applications. In contrast, anodes of graphite are chosen because of the ability of lithium to intercalate the carbon without excess volumetric expansion. High volumetric expansion causes degradation of the battery and a large amount of irreversibility rendering the battery useless for any application with a need for rechargeable energy storage. For example, Li⁺ insertion and removal within high-capacity materials such as Si and Ge causes a volume change of 370-400% that can induce particle cracking and pulverization. Particle cracking and pulverization, in turn, can form insulated fragments and create new surfaces that consume lithium, thus causing irreversiblilty that eventually translate into a rapid loss in capacity, and the failure of the battery. The volume change can also cause disconnections between the active materials and the interruptions in current collections.

In recent years, the cycling stabilities of batteries have been improved considerably, benefiting from various strategies that negate the influences of volume change and severe structural stress on capacity retention. In particular, the strategies include (i) tolerance enhancement, such as decreasing dimensional size (Li, H. et al. Electrochem. Solid State Lett. 2, 547-549 (1999); Chan, C. K. et al. Nat. Nanotechnol. 3, 31-35 (2008); Kim, H. et al. Angew. Chem. Int. Ed. 49, 2146-2149 (2010); Wang, X. L. & Han, W. Q. ACS Appl. Mater. Interfaces 2, 3709-3713 (2010); each of which is incorporated herein by reference in its entirety), and amorphization (Obrovac, M. N. & Krause, L. J. J. Electrochem. Soc. 154, A103-A108 (2007); Fan, Q. et al. Electrochem. Solid State Lett. 10, A274-A278 (2007); Cui, L. F. et al. Nano Lett. 9, 491-495 (2009); each of which is incorporated herein by reference in its entirety); (ii) accommodation, such as pore formation (Zhang, W. M. et al. Adv. Mater. 20, 1160-1165 (2008); Park, M. H., et al. Adv. Mater. 22, 415-418 (2010); each of which is incorporated herein by reference in its entirety); (iii) buffering, viz., making composites with carbon and/or inactive components, carbon coating, alloying, thin filming, and modifying binders and the solid electrolyte interface (SEI) layer coating (Xing, W. B. et al. J. Electrochem. Soc. 144, 2410-2416 (1997); Kepler, K. D. et al. Electrochem. Solid State Lett. 2, 307-309 (1999); Mao, 0. et al., J. Electrochem. Soc. 146, 405-413 (1999); Xu, K. Chem. Rev. 104, 4303-4417 (2004); Graetz, J. et al., Electrochem. Soc. 151, A698-A702 (2004); Li, J. et al., Electrochim. Acta 55, 2991-2995 (2010); Guo, J. C. et al., J. Mater. Chem. 20, 5035-5040 (2010); each of which is incorporated herein by reference in its entirety); and, (iv) limitation, e.g., narrowing the voltage window and fixing the lithiation level (Besenhard, J. O. et al., J. Power Sources 68, 87-90 (1997); Courtney, I. A. & Dahn, J. R. J. Electrochem. Soc. 144, 2045-2052 (1997); each of which is incorporated herein by reference in its entirety).

Several recent reports have documented good cell stability, i.e., high capacities without a discernible decline for at least a hundred full cycles, in tailored nanostructures (Takamura, T., et al. J. Power Sources 129, 96-100 (2004); Wang, Y., et al. Adv. Mater. 18, 645-649 (2006); Hassoun, J. et al. Adv. Mater. 19, 1632-1635 (2007); Derrien, G. et al. Adv. Mater. 19, 2336-2340 (2007); Yu, Y. et al. Adv. Mater. 19, 993-997 (2007); Kim, H. et al. Angew. Chem. Int. Ed. 47, 10151-10154 (2008); Hu, Y. S. et al. Angew. Chem. Int. Ed. 47, 1645-1649 (2008); Yu, Y. et al. Angew. Chem. Int. Ed. 48, 6485-6489 (2009); Yoon, S. & Manthiram, A. Chem. Mater. 21, 3898-3904 (2009); Hertzberg, B. et al. G. J. Am. Chem. Soc. 132, 8548-8549 (2010); Magasinski, A. et al. ACS Appl. Mater. Interfaces 2, 3004-3010 (2010); Yu, Y. et al. Adv. Mater. 23, 2443-2447 (2011); each of which is incorporated herein by reference in its entirety).

These nanostructures generally are grouped into two classes, a carbon composite and a thin film. For example, a hierarchical porous structure of 10-30 nm Si nanoparticles (˜50 wt %) deposited on 15-35-μm chained carbon-black particles attained an overall capacity of 1,500 mAh g⁻1 for 100 cycles (Magasinski, A. et al. Nat. Mater. 9, 353-358 (2010), incorporated herein by reference in its entirety). However, both classes have several disadvantages. In carbon composites (in some cases the added carbon comprises over half weight of the composites), the following drawbacks were evident: i) the presence of low-capacity carbon suppressed overall energy-density; ii) the synthesis usually involved multiple complicated steps; iii) the intact surface coating decreased the electrode's kinetics; and, iv) carbon afforded only limited accommodation, so the composites needed either to be porous to provide pre-formed voids, or required inactive oxides to buffer the volume change, which magnifies the other three disadvantages effects. Meanwhile, thin-films are suitable only for micro-batteries, and their performance must be stabilized via thick inactive substrates. Therefore, the challenge to formulate an inexpensive and high performance material without a carbon coating has been an attractive goal.

### SUMMARY

In meeting the goal of this challenge, a novel germanium oxide (GeOₓ) compound is disclosed, where x is between 0.01 and 1.99. This germanium oxide compound forms nanoscale hierarchical porous agglomerates showing high capacity (e.g., 1,250 mAh/g), high diffusivity of lithium, and enhanced cycling stability. Without being bound by any particular theory, it is believed that the enhanced cycling stability of these materials is due to (1) the formation of ultrafine primary nanoparticles, (2) amorphization, (3) the nanoscale pore formation, and (4) the incorporation of oxygen.

In particular, the primary particles of germanium oxide have dimensions at the shortest cross-section of less than 100 nm (e.g., from 1 nm to 100 nm), which preferably are amorphous and are assembled into nano-agglomerates. It is also contemplated that the primary germanium oxide particles may be partially or fully crystalline. The nano-agglomerates can have a shape of a nanowire, nanobelt, nanoparticle, nanocrystal, nanorod, nanotube, nanocube or nanosheet or other forms of nanomaterials. The nano-agglomerates can be further assembled into macro- and/or micro-agglomerates. Typically, agglomeration leads to poor performance stemming from increased diffusion lengths, as well as mechanical instabilities caused by the volume changes that occur during the insertion and extraction process of lithium ions. However, the formation of nanopores or interstitial voids in the agglomerates that can range in size from about 0.1 nm to about 20 nm overcomes the problems associates with agglomeration. In one embodiment, the germanium oxide compound can be further doped with alkali metals, transition metals, non-metals, or halogens, including, but not limited to, Li, Na, K, B, C, N, F, Al, Si, P, S, Ca, Sc, V, Cr, Mn, Fe, Co, Ni, Cu, and Zn. It will be understood by those skilled in the art that other substitutions and additions of metals, non-metals, or halogens in the present germanium oxide compound are contemplated without departing from the spirit and scope of this invention.

The present compositions can be further encompassed in an electrode, preferably an anode, composed of a germanium oxide compound, a conductive additive, e.g., carbon black, and a binder, e.g., lithium polyacrylate. In one embodiment, the composition of the germanium oxide compound, additive, and binder is about 60% to 90% of the germanium oxide compound, 5% to 30% of additive, and 5% to 15% of binder. In a preferred embodiment the composition of the germanium oxide, additive, and binder is 80:10:10. The present compositions further can encompass an electrochemical cell, i.e., a battery, having a cathode, an anode, and an electrolyte solution. In a preferred embodiment, the electrochemical cell is a lithium-ion battery having an anode composed of the present germanium oxide compound.

These and other characteristics of the germanium oxide compound and method(s) of synthesis of such compounds will become more apparent from the following description and illustrative embodiments, which are described in detail with reference to the accompanying drawings. Similar elements in each figure are designated by like reference numbers and, hence, subsequent detailed descriptions of such elements have been omitted for brevity.

### BRIEF DESCRIPTION OF THE DRAWINGS

FIGS. 1A-1B are SEM images of the initial GeOₓ with increasing area of magnification. FIG. 1B is an enlarged SEM image corresponding to the area enclosed by a square in FIG. 1A.

FIG. 1C is a TEM image corresponding to an area similar to that shown in the square in FIG. 1B.

FIG. 2A is a synchrotron XRD profile of the initial GeOₓ. Powder Diffraction File (PDF) peaks of Ge and GeO₂ references are also shown in the figure.

FIG. 2B shows a synchrotron EXAFS profile of the initial GeOₓ. Synchrotron EXAFSs of Ge and GeO₂ references are also shown.

FIGS. 3A-3B are SEM images of 300° C.-sample of nanoporous structures. Enlarged SEM image in FIG. 3B corresponds to a square area in FIG. 3A.

FIG. 3C is a TEM image of 300° C.-sample of nanoporous structures corresponding to an area similar to that shown in a square area in FIG. 3B.

FIG. 4 is a low-magnification SEM image of 700° C. sample of nanoporous structures.

FIG. 5 shows a plot of XRD profiles where Powder Diffraction File (PDF) peaks of Ge reference are depicted.

FIG. 6 shows a plot of reversible capacities of different anodes in half cells at constant-current (CC) rates of C/20 (80 mA g⁻¹), C/5 (320 mA g⁻¹), and C/2 (800 mA g⁻¹) between 0.05 V and 1.5 V.

FIGS. 7A-7B show a low-magnification SEM image and a STEM dark-field image of the lithiated sample of the initial GeOₓ anode in the 200^{th} cycle, respectively.

FIGS. 8A-8B are plots of ex-situ synchrotron XRD profiles of the 700° C. sample at different states of cycling, and ex-situ synchrotron XRD profiles of the initial GeOₓ samples at different states of cycling, respectively.

FIGS. 9A-9D illustrate selected area electron diffraction (SAED) patterns of the (de-)lithiated samples of the initial GeOₓ anode. A, After the first lithiation (+Li₂O), B, After the first delithiation (−LiF), C, After the 200^{th} lithiation (+Li₂O), and D, After the 200^{th} delithiation (−LiF).

FIG. 10A shows a plot of initial constant-current (CC) (de-)lithiation profiles of the GeOₓ anode with Li compensation in the half cell at C/2 compared to ones without Li compensation at C/20.

FIG. 10B shows a plot of initial constant-current-constant-voltage (CCCV) charge-discharge profiles of the Li-compensated GeOₓ/NCM full cell at ˜C/20 (14 mA g_{(NCM)}¹) in comparison with those of the Li metal/NCM half cell.

FIG. 11 shows a plot of reversible battery discharge-capacity of NCM in the full cell at CCCV rates of ˜C/20 (14 mA g_{(NCM)}¹) and C/2 (140 mA g_{(NCM)}⁻¹) between 2.5 V and 4.2 V.

### DETAILED DESCRIPTION

A novel germanium oxide compound is disclosed that is composed of germanium and oxygen having a formula (1),

GeOₓ, (1)

where 0.01≦x≦1.99. In a preferred embodiment, x is between 0.01 and 1.50, while in a more preferred embodiment, x is between 0.10 and 1.00, and in the most preferred embodiment x is about 0.67. The germanium oxide compound forms nanoscale hierarchical porous agglomerates showing high capacity (e.g., 1,250 mAh/g), high diffusivity of lithium, and enhanced cycling stability. The disclosed GeOₓ compound(s) exhibit enhanced or superior performance, including structural stability and reactivity, due to one or more of the following characteristics, such as the formation of ultrafine primary nanoparticles, amorphization, pore formation, preferably nanoscale, and the incorporation of oxygen in its structure. While any one of these characteristics can influence and enhance performance independently, it is contemplated that the superior performance is derived from the synergy of all four characteristics. Among these characteristics, it is believed that the small (nanoscale) size of primary particles plays a crucial role in the enhanced performance of the GeOₓ materials because the widespread problem of pulverization of the assembled electrodes, preferably anodes, can be avoided. For example, Yoon et al. reported that micron-sized Ge particles when used as anodes in Li-ion batteries were broken into 5-15 nm fragments after several cycles (Electrochem. Solid State Lett. 11, A42-A45 (2008); incorporated herein by reference in its entirety). Because the size of the primary particles of germanium oxide is already nanoscale, i.e., less than 100 nm and preferably less than 10 nm, such breakdown is unlikely to occur. Moreover, maintaining only small change in the absolute volume of each primary particle helps the agglomerates to preserve the electrical contact between particles, as well as the integrity of the individual particle. For example amorphous GeO_{0.67} only needs 1.38 times opening spacing to accommodate volume expansion during a full lithiation. The small size of the primary particles also enhances reactivity due to the increased number of surfaces available for the reaction and facilitates both ionic and electronic charge transfer over a shorter distance.

Besides the germanium oxide composition having very small (nanoscale) primary particles, it is also believed that the amorphous structure of the particles is responsible for enhanced stability of the composition during high-capacity cycling. For example, Kim et al. showed that while ultrafine crystallites (<10 nm) of Si lose (fade) about 24% of their capacity after 40 cycles (Kim et al. 2010), mesoporous Si particles retain about 76% of their capacity after 50 cycles. (Nano Lett. 8, 3688-3691 (2008); incorporated herein by reference in its entirety). This suggests that upon (de-)lithiation crystallite based electrodes (anodes) undergo anisotropic expansion/extraction, which results in rapid fading of their capacity. Thus, it is observed that amorphous Ge particles avoid capacity fading due to the harmful anisotropic expansion/extraction.

Furthermore, the porosity also plays an important role in stabilizing the integrity and the capacity of the particles. Typically, anode particles need room for expansion during lithiation, even if they are small and amorphous. If there is only limited room for expansion, contractive stresses build up and the cracks develop that may lead to breakdown of the microscopic charge-transportation pathways leading to a loss in the electrical contact.

The incorporation of oxygen plays an important role in enhancing the stability of the primary particles, while maintaining their high capacity for use in anodes. In particular, the germanium oxide (GeOₓ) of formula (1) has a higher theoretical capacity than pure germanium (Ge). For example, GeO_{0.67} has a theoretical capacity of 1845 mAh/g, whereas pure Ge has a lower theoretical capacity of 1600 mAh/g. The incorporation of oxygen also reduces the volume expansion because the oxygen forms di-lithium oxide (Li₂O) with reversible lithium, whereas in pure germanium, the Ge atoms form GeLi_{4.4} with reversible lithium. In comparison the formation of di-lithium oxide results in volume expansion of 72.9%, whereas the formation of GeLi_{4.4} results in volume expansion of 270%. Furthermore, it is believed that the atomic arrangement and bonding of germanium oxide (GeOₓ) is closer to pure Ge rather than to GeO₂. Therefore, GeOₓ retains the excellent lithium-ion diffusivity (400 times faster than in Si) and the high electrical conductivity of the pure germanium.

When the present GeOₓ compounds are directed to electrodes, they are made from the germanium oxide particles, preferably amorphous, or agglomerates of such particles having one or more nanopores or interstitial voids. The present compounds can also be directed to the electrochemical systems that use such electrodes. In addition, a method of synthesizing the germanium oxide materials of formula (1) is disclosed. It is to be understood, however, that those skilled in the art may develop other structural and functional modifications without significantly departing from the scope of the disclosed invention.

### I. Amorphous and Crystalline Germanium Oxide Material(s)

The germanium oxide material(s) can form nanoporous agglomerates that at a minimum include a primary nanoparticle of germanium oxide compound having a substoichiometric composition of GeOₓ where x is between 0.01 and 1.99, between 0.01 and 1.50 or about 0.67. The O occupancy in the germanium oxide GeOₓ compound has a Ge/O molar ratio of about 0.5 to about 100. The upper range of Ge/O molar ratios, e.g., about 100, indicates a non-stoichiometry of the germanium oxide compound and the presence of vacancies at O sites. The vacancies at O sites can be ordered (periodic) or disordered (random). While it is preferred that the primary particles of germanium oxide of formula (1) are amorphous, the primary particles can also be partially or fully crystalline.

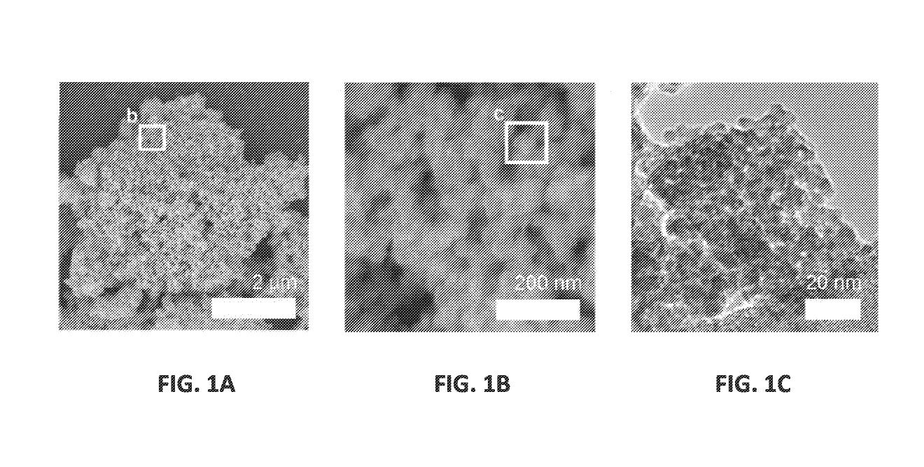

The germanium oxide primary particles have a size of less than 100 nm (e.g., from 1 nm to 100 nm,), and preferably less than 10 nm. In one embodiment, the primary germanium oxide particles can be assembled into nano-agglomerates. The nano-agglomerates can be further assembled into macro- and/or micro- agglomerates. Typically, micro- and macro-agglomerates are assembled from one or more nano-agglomerates of the same, similar or different sizes, e.g., 20 nm, 50 nm, 100 nm, etc. In one exemplary embodiment illustrated in FIG. 1A, the agglomerates formed from germanium oxide material(s) of formula (1) have a diameter of about 5 μm made from nano-agglomerates each having a diameter of about 50 nm, e.g., see FIG. 1B. However, there are no particular limitations on the sizes of agglomerates as long as they have ordered or disordered nanopores or interstitial voids that preferably range in size from about 0.1 nm to about 20 nm in order to reduce the diffusion length and overall stability. In a preferred embodiment, the surface area of nanopores is between 10 m² g⁻¹ and 2000 m² g⁻¹ and the total pore volume is between 0.01 cm³ g⁻¹ and 10 cm³ g⁻¹. Typically, agglomeration leads to poor performance, stemming from increased diffusion lengths as well as mechanical instabilities caused by the volume changes that occur during the insertion and extraction process of lithium ions. However, the formation of nanopores or interstitial voids in the agglomerates overcomes the problems associates with agglomeration.

In another embodiment, the germanium oxide compound can further be doped with alkali metals, transition metals, non-metals, or halogens, including, but not limited to, Li, Na, K, B, C, N, F, Al, Si, P, S, Ca, Sc, V, Cr, Mn, Fe, Co, Ni, Cu, and Zn.

### II. Electrodes and Electrochemical Cells

As with most batteries, the electrochemical cell has an outer case made of metal or other material(s) or composite(s). The electrochemical cell is preferably a non-aqueous battery. The case holds a positive electrode (cathode); a negative electrode (anode); a separator and an electrolytic solution, where the germanium oxide material(s) of the present invention can be used in production of the anode.

As an anode in the Li-ion battery, germanium oxide of formula (1) can provide high capacity, high Coulomb efficiency, long cycling life, and high full-cell performance. It is contemplated that the capacity of the anodes containing the germanium oxide material(s) of formula (1) are between 500 and 2000 mAh g⁻¹, the efficiency is between 95% and 100% and the cycling life is more than 100 cycles. Preferably, the anode is composed of a germanium oxide compound, a conductive additive, and a binder. The composition of the germanium oxide compound, additive, and binder is about 60% to 80% of the germanium oxide compound, 10% to 30% of additive, and 5% to 15% of binder. In a preferred embodiment the composition of the germanium oxide compound, additive, and binder is 80:10:10. The present compositions can be further encompassed in an electrochemical cell, i.e., a battery, having a cathode, an anode, and an electrolyte solution. In a preferred embodiment, the electrochemical cell is a lithium-ion battery having an anode composed of the present germanium oxide compounds.

In one embodiment, both the anode and cathode are formed from materials that allow lithium migration. For example, when the battery charges, lithium ions move through the electrolyte from the positive electrode to the negative electrode and attach to the germanium oxide particles. During discharge, the lithium ions move back to the cathode from the anode. Inside the case both the anode and the cathode are submerged in an organic solvent that acts as the electrolyte. The electrolyte is composed of one or more salts, one or more solvents, and, optionally, one or more additives.

The electrode may include at least one of the germanium oxide macro-, micro-, or nano-materials having a formula GeOₓ, where x is between 0.01 and 1.99, preferably between 0.01 and 1.50, more preferably between 0.10 and 1.00, and most preferably about 0.67. With specific reference to the anode, a preferred anode for the disclosed germanium oxide material, may further comprise a conductive additive such as a carbon- or lithium-based alloy. The carbon may be in the form of graphite such as, for example, mesophase carbon microbeads (MCMB). Lithium metal anodes may be lithium mixed metal oxide (MMOs) such as LiMnO₂ and Li₄Ti₅O₁₂. Alloys of lithium with transition or other metals (including metalloids) may be used, including LiAl, LiZn, Li₃Cd, Li₃Sd, Li₄Si, Li_{4.4}Pb, Li_{4.4}Sn, LiC₆, Li₃FeN₂, Li_{2.6}Co_{0.4}N, Li_{2.6}Cu_{0.4}N, and combinations of these metals. The anode may further comprise another metal oxide including SnO, SnO₂, GeO, GeO₂, In₂O, In₂O₃, PbO, PbO₂, Pb₂O₃, Pb₃O₄, Ag₂O, AgO,

Ag₂O₃, Sb₂O₃, Sb₂O₄, Sb₂O₅, SiO, ZnO, CoO, NiO, FeO, and combinations of these metal oxides. The anode may further comprise a polymeric binder. In a preferred embodiment, the binder may be polyvinylidene fluoride, styrene-butadiene rubber, polyamide or melamine resin, and combinations of these binders. Lithium powder may optionally be used together with the germanium oxide material. The suitable molar ratio between lithium powder and GeO is between 1:0.001 and 1:100, preferably 0.5:1.0.

With specific reference to the cathode, it may include one or more lithium metal oxide compound(s) optionally composed with the germanium oxide material. In particular, the cathode may comprise at least one lithium mixed metal oxide (Li-MMO). Lithium mixed metal oxides contain at least one other metal selected from the group consisting of Mn, Co, Cr, Fe, Ni, V, and combinations of these metals. For example the following lithium MMOs may be used in the cathode: LiMO₂ (M═Co, Ni, Mn or a combination thereof), LiM₂O₄ (M═Co, Ni, Mn or a combination of these metals), LiMPO₄ (M=Fe, Co, Ni, Mn or a combination of these metals), Li₂Cr₂O₇, Li₂CrO₄, LiFeO₂, LiNiₓCo₁₋ₓO₂ (0<x<1), LiFePO₄, LiMn_{z}Ni_{1-z}O₂ (0<z<1; LiMn_{0.5}Ni_{0.5}O₂), LiMn_{0.33}Co_{0.33}Ni_{0.33}O2, LiMc_{0.5}Mn_{1.5}O₄, where Mc is a divalent metal; and LiNiₓCo_{y}Me_{z}O₂, where Me may be one or more of Al, Mg, Ti, B, Ga, or Si and 0<x, y, z<1. Furthermore, transition metal oxides such as MnO₂ and V₂O₅, transition metal sulfides such as FeS₂, MoS₂, and TiS₂, and conducting polymers such as polyaniline and polypyrrole may also be present. The preferred positive electrode material is the lithium transition metal oxide, including, especially, LiCoO₂, LiMn₂O₄, LiNi_{0.8}Co_{0.15}Al_{0.05}O₂, LiFePO₄, and LiNi_{0.33}Mn_{0.33}Co_{0.33}O₂. Mixtures of such oxides may also be used. Similar to the anode, the cathode may further comprise a polymeric binder. In a preferred embodiment, the binder may be polyvinylidene fluoride, styrene-butadiene rubber, polyamide or melamine resin, and combinations thereof. Preferably, the full-cell capacity is between 100 and 200 mAh g_{cat}⁻¹.

Although, a preferred embodiment has been described with reference to the lithium ion based electrochemical cells, it is also envisioned that the germanium oxide materials of the present invention can also be successfully applied to other electrochemical cells, such as hybrid electrochemical cells (HEC), supercapacitors, fuel cells, and other conductors.

### III. Synthesis of the Germanium Oxide Materials

The present compositions further encompass a method for synthesizing germanium oxide compound(s) having a formula GeO by employing a modified in-situ one pot wet-chemistry method. The method includes preparing germanate ions by reacting a germanium precursor with a hydroxide ion precursor in a solvent under a first controlled temperature, i.e., 0° C. to 250° C. for about 5 minutes to about 50 hours. The germanium precursor is not particularly limited as long as it can generate a germanate ions in combination with a hydroxide source. For example, the germanium precursor can be selected from GeO₂, GeO, GeCl₂, GeCl₄, GeS, Ge(OCH₃)₄ and Ge(CH₃)₄. Similarly, the hydroxide ion precursor includes, but not limited to, NH₄OH, NaOH and KOH. The synthesis is preferably done in an aqueous solvent, however, other solvents can also be readily used such as ethanol, tetraethylene glycol, ethylene glycol, triethylene glycol, hexane, toluene, and chloroform. Depending on the selection of the solvent, the germanium precursor, and the hydroxyl ion precursor, the time and temperature of the reaction may be adjusted accordingly without departing from the scope and spirit of the invention. Preferably, the molar ratio of Ge to OFF is between about 1:0.1 and about 1:100 and the concentration of hydroxide ion solution is between 0.1 mol/L and 10 mol/L.

In the second part of the method, the generated germanate ions are reduced using a reducing agent for another 5 minutes to 50 hours under the second controlled temperature, which may be same, similar or different from the first controlled temperature. The examples of the reducing agent include, but are not limited to, NaBH₄, Oleylamine, n-Butyl Li, Li metal, ascorbic acid and LiAlH₄. Preferably, the molar ratio of Ge and the reducing agent is between about 1:0.1 and about 1:100. The resulting germanium oxide can be collected by various methods known in the art, for example, filtration with additional steps of washing, and drying under vacuum. The final germanium oxide material produced after the second step generally has amorphous structure assembled into nanoporous agglomerates.

While the germanium oxide materials, the electrodes and the electrochemical cells based on such materials have been described in connection with what is presently considered to be the most practical and preferred embodiment, it is to be understood that the invention is not to be limited to the disclosed embodiments, but on the contrary, is intended to cover various modifications and equivalent arrangements included within the spirit and scope of the appended claims.

### EXAMPLES

The examples set forth below also serve to provide further appreciation of the invention but are not meant in any way to restrict the scope of the claimed invention.

### Example 1

Amorphous GeOₓ agglomerates were prepared in ammonia solution at room temperature by a modified procedure previously used for preparing worm-like crystalline Ge nanostructures (Jing, C. B. et al. Nanotechnology 20, 505607 (2009), incorporated herein by reference in its entirety). The synthesis begins with the formation of germanate ions by reacting GeO₂ with NH₄OH, and the subsequent reduction of these ions using NaBH₄. First, 8 g GeO₂ (99.999%, Aldrich) was stirred in 144 ml distilled water. After adding 16 ml NH₄OH (28.0-30.0% NH₃, Alfa), the dispersion became transparent. Then, a fresh NaBH₄ (98%, Alfa) solution (14.464 g in 80 ml water) was injected into the solution. The mixture was stirred continuously for about 20 hours. The resulting powder was collected by filtration, washed with distilled water, and dried under vacuum.

### Example 2

FIGS. 1A-1C illustrate the synthesized hierarchical porous nanostructure. The structure of the prepared amorphous germanium oxide agglomerates was examined using Hitachi S-4800 scanning electron microscope (SEM) and a JEM-2100F transmission electron microscope (TEM). The energy dispersive X-ray spectroscopy (EDS) was used in the TEM for measurements in the scanning transmission electron microscopy (STEM) mode. The low-magnification SEM image in FIG. 1A shows micrometer-sized agglomerates having a plurality of nanopores. As depicted in FIG. 1B at higher magnification, there are about 50 nm-sized nano-agglomerates. Further increasing magnification as illustrated in FIG. 1C under TEM shows the presence of 3.7±1.0 nm primary nanoparticles. Nitrogen-absorption measurements using a TriStar II 3020 analyzer determined a Brunauer-Emmett-Teller (BET) surface area of 187 m²/g.

### Example 3

High-resolution synchrotron X-ray diffraction (XRD) measurements confirmed the amorphous structure of the materials prepared in Example 1. The synchrotron X-ray diffraction experiments were carried out on beamline X14A (λ=0.72958 Å) of the National Synchrotron Light Source (NSLS) at Brookhaven National Laboratory. The diffraction patterns were collected in a Q-range from 0.5 to 8.7 Å-1, with a Si strip detector at a 0.005° step-size. The initial GeOₓ sample was loaded in a single-crystalline sapphire tube, and the (de-)lithiated samples were loaded in glass capillaries.

Powder X-ray absorption samples were prepared by brushing the powders on to Kapton tape and stacking the tape to optimize absorption. The amorphous sample was measured in fluorescence mode as prepared, while the reference samples were ground and sieved through a 500 mesh and measured in transmission mode. The Ge K-edge X-ray absorption data were collected at NSLS X11A beamline using a Si(111) double-crystal monochromator detuned by 50% to suppress harmonic contamination. For calibration, a Ge sample was used as an internal reference. Two to four scans were averaged to obtain statistically significant data at high energy. The x-ray absorption fine-structure (XAFS) data was reduced via standard procedures. The x-ray data plots were obtained by a Fourier transform over the range of 2.75<k<16.4 Å⁻¹.

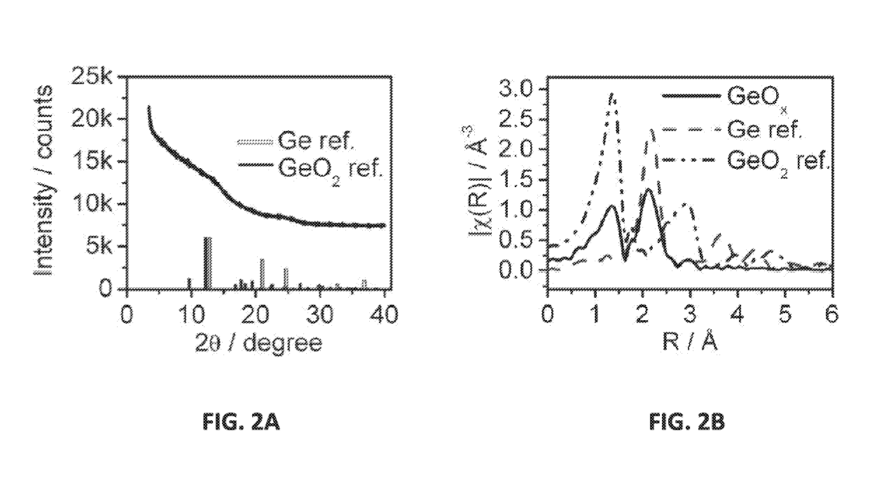

As illustrated in FIG. 2A, the intensity in the XRD profile declines smoothly with increasing 20° angles. Only two bumps can be seen around 13° and 24° but no sharp peaks are present. Assuming that the first bump reflects Ge(111), the size of the short-range-order was estimated using the Scherrer formula known in the Art to be about 8 Å.

### Example 4

The scanning transmission electron microscopy-energy dispersive X-ray spectroscopy (STEM-EDS) measurements of the materials prepared in Example 1 indicate that the oxygen-weight ratio is about 13 wt %, or the molar ratio of Ge/O is 6:4. Synchrotron extended X-ray absorption fine structure (EXAFS) spectra at Ge K-edge, (see FIG. 2B, Fourier transformed, but not phase corrected) also confirmed the existence of oxygen in the sample prepared according to Example 1. The Ge atoms in this sample form the first coordination shell, with similar Ge—Ge bond length as in crystalline Ge, and oxygen atoms form the second coordination shell with Ge—O bond length similar to the case of GeO₂.

### Example 5

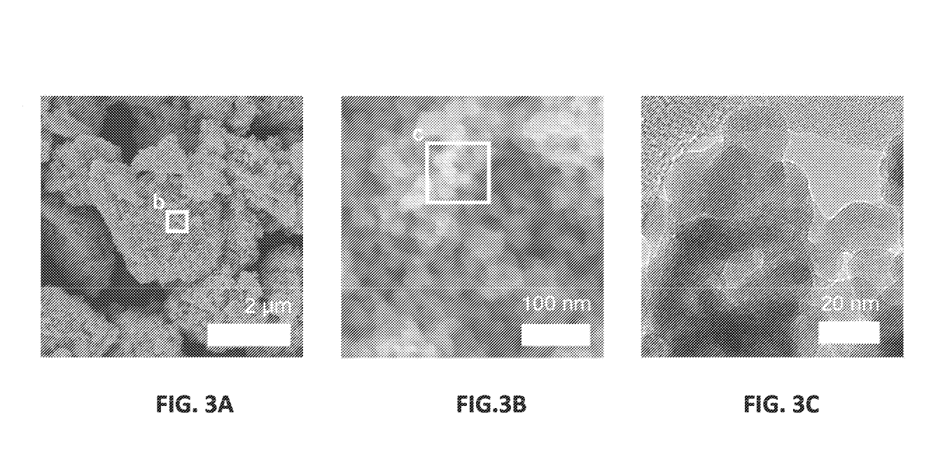

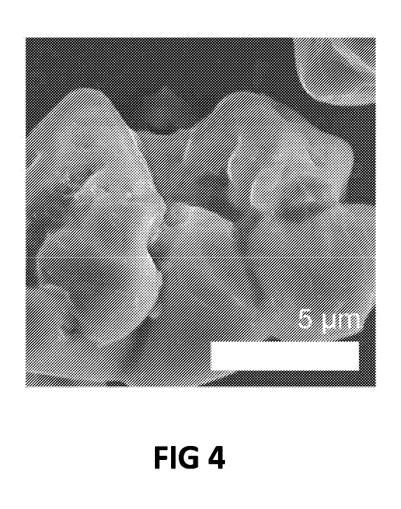

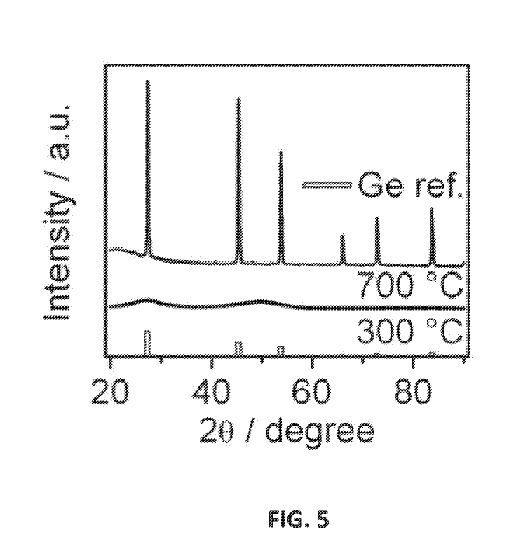

For comparison, samples were annealed in H₂ at 300° C. and at 700° C. for 30 minutes. The X-ray diffraction (XRD) patterns of the 300° C. and the 700° C. samples were collected by a Rigaku/Miniflex II diffractometer with Cu Kα radiation. The 300° C. sample retained its micron-sized agglomerates consisting of ˜20 nm nanoparticles (see FIGS. 3A-3B), and its structure remained amorphous (see FIG. 5). However, the structure of the 3.7 nm primary particles described in Example 4 was lost as illustrated in FIG. 3C. The surface area of the agglomerates also decreased to 58.3 m² g⁻¹. In contrast, the sample annealed at 700° C. only retained solid micron-sized crystalline particles (see FIG. 4 and FIG. 5).

### Example 6

When employed as an anode material in Li-ion batteries, the GeOₓ sample prepared in Example 1, carbon black (Super P Li, TIMCAL), and a lithium polyacrylate (Li-PAA) binder were combined at a ratio of 80:10:10 by weight on surface treated Cu foils (0.025 mm thick, Schlenk) that serve as the current collector. Li-PAA was made by reacting poly (acrylic acid) (PAA, Mv˜450,000, Aldrich) with stoichiometric amount of LiOH.H₂O (98.0+%, Aldrich) in water. Cathode films were made from Li(NiCoMn)₁/3O₂, carbon black and poly(vinylidene fluoride) (PVDF, Alfa) with 80:10:10 wt coated on Al foils (0.025 mm thick, 99.45% metals basis, Alfa). The electrolyte solution was 1.0 M LiPF₆ in ethylene carbonate/dimethyl carbonate (1:1 by volume, Novolyte) with 5 vol % vinylene carbonate (97+%, Alfa). A 20 μm polyolefin microporous membrane (Celgard 2320) served as the separator. 2032-type coin cells were fabricated inside an M. Braun LabMaster 130 glove box under Ar atmosphere. Cell cycling was performed using an Arbin MSTAT system.

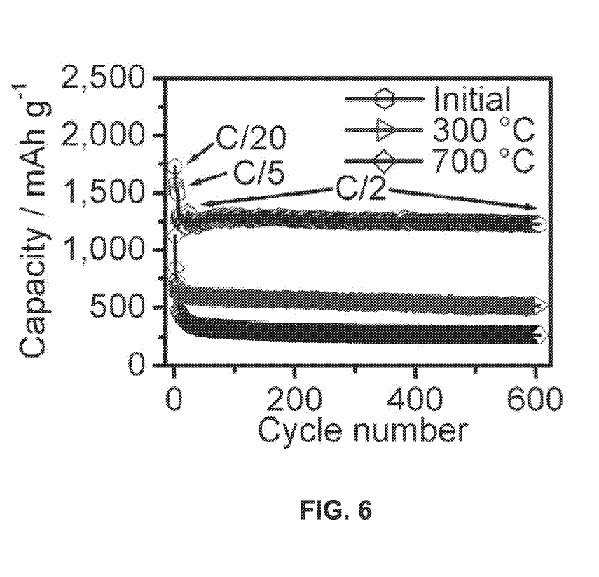

When employed as an anode material in Li-ion batteries, the initial GeOₓ sample had a very stable cycling behavior with a highly reversible capacity. As illustrated in FIG. 6, its initial C/20 (80 mA g⁻¹) reversible capacity was 1,728 mAh g⁻¹. Afterwards, the C/5 and C/2 capacities, respectively, were 1,575 mAh g⁻¹ and 1,268 mAh g⁻¹. The anode retained its capacity for 600 full charge/discharge cycles when cycled at the rate of C/2. The capacity of the 600^{th} C/2 cycle was still 96.7% of that of the first one.

FIG. 6 also shows that increasing size of the amorphous particles (annealed at 300° C.; see Example 5) decreased the capacity of the anode from 688 mAh g⁻¹ at C/20, 661 mAh g⁻¹ at C/5, to 607 mAh g⁻¹ at C/2. Nevertheless, cycling stability was still considered to be exceptional. Furthermore, along with the reduction in the porous amorphous structure, the anode (similar to the 700° C. sample) behaves like a bulk alloy system and its capacity fades rapidly in the first few cycles and stabilizes at an inferior stage.

### Example 7

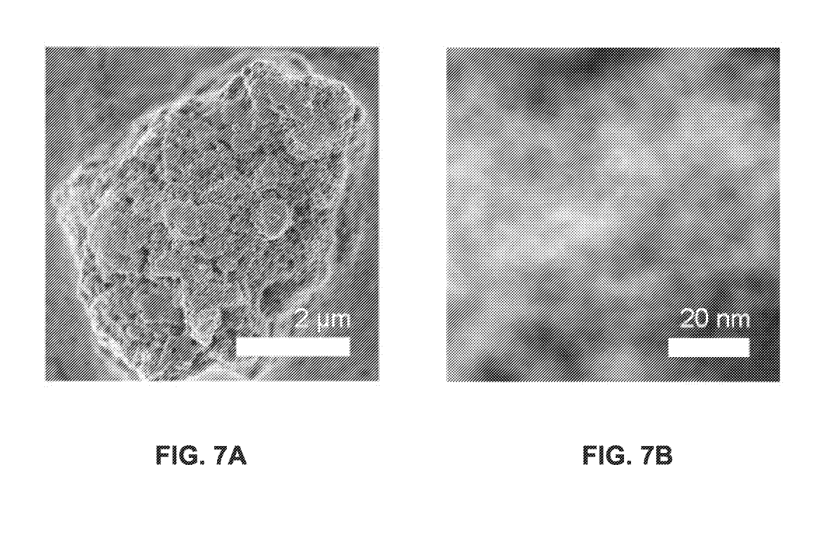

To explore the intrinsic reasons behind the impressive cycling performance of the original GeOₓ sample made according to Example 1 as compared to the annealed samples of Example 5, the anode made from the original GeOx sample was subjected to more than 600 charge/discharge cycles and the microstructures of the anode were extracted and studied ex-situ. FIG. 7A of the SEM image and FIG. 7B of the STEM dark-field image show that the micron-sized agglomerates and small primary particles are preserved after extensive cycling. It was also observed that the amorphous state was also retained during cycling. In addition, the anode still had good electrochemical reactivity, as evidenced by the higher capacity compared with the control anodes shown in FIG. 6. However, increasing the size of the particles to 20 nm from 3.7 nm resulted in lower capacities, however good stability was still maintained at this level of lithiation as compared to the annealed 300° C. sample.

### Example 8

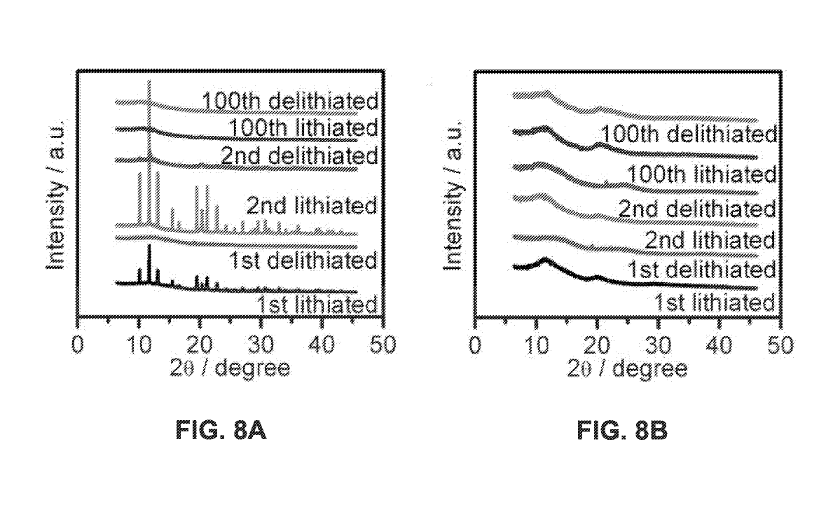

The ex-situ synchrotron XRD study noted in Example 7 also revealed that crystalline Ge experienced different kinds of dramatic changes in atomic-structure upon (de-)lithiation. As illustrated in FIG. 8A, at the end of the first lithiation, the anode was characteristically dominated by the Li₁₅Ge₄ phase. However, after the first delithiation, amorphization took place, with the size of Ge(111) short-range order of about 6 Å. These findings agree with those of a previous XRD study of Ge anodes also pointing out that several other Li—Ge intermetallics form at different states of charge during this progression. (Yoon et al. 2010) Moreover, lithiating the amorphous product a second time resulted in the recrystallization of the Li₁₅Ge₄ phase. Subsequent delithiation, however, returned the system to the amorphous state, with possible residual lithiated phases. After 100 cycles, the anode kept its amorphous state on both charge and discharge. It is believed that this might be due to a large activation energy and/or insufficient lithium uptake as the particles deteriorate.

### Example 9

The stability during cycling of the initial GeOₓ also benefits from the material's amorphous state. As depicted in FIG. 8B, the change in the crystal structure appears to be mild during cycling of the initial GeOₓ. Two major bumps mark the profile of the first lithiation at positions ˜11.5° and ˜20°, which migrate to the left after several charge/discharge cycles compared with the original profile. Several Li—Ge intermetallics (e.g., Li₂₂Ge₅, Li₁₅Ge₄ and Li₇Ge₂) have major peaks in these regions, which might reflect the formation of short-range-ordered lithiated Ge. The XRD patterns of the first delithiated sample are reminiscent of those of original GeOₓ prepared in Example 1. The structure after the second cycle largely mimicked that of the first one. The amorphous phase was still preserved after 100 cycles.

### Example 10

Porosity also plays an important role in stabilizing the capacity. The initial GeOₓ prepared according to Example 1 had a Barrett-Joyner-Halenda (BJH) pore-volume of 0.34 cm³ g⁻¹. For simplification, the density of crystalline Ge is used in calculations. Thus, the pore of a 1 g sample can accommodate a 1.81 times increase in volume. Taking into account the change in the volume of oxygen in the sample, this opening space could well accommodate the volume change.

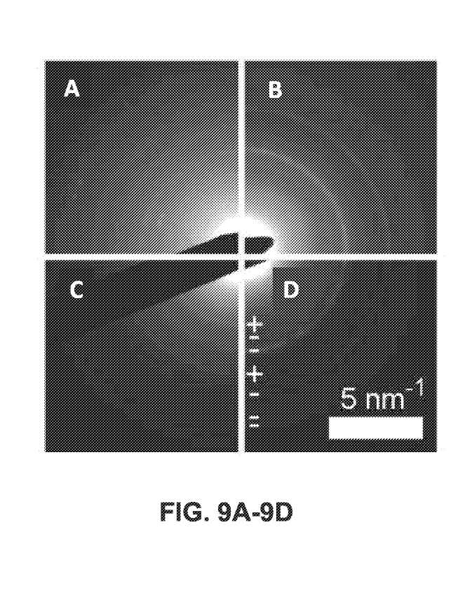

Rough calculations using the crystal ionic radii of O²⁻ (126 pm) and Ge²⁺ (87 pm) (Shannon, R. D. Acta Cryst. A 32, 751-767 (1976); incorporated herein by reference in its entirety) and the Ge/O molar ratio of 1.5 yields a Ge/O volume ratio of 1:2.02 in the initial GeOₓ. Oxygen could form Li₂O with reversible lithium, as suggested by the selected area electron diffraction (SAED) patterns of the lithiated samples that comprise diffraction rings from both LiF and Li₂O, while those of the following delithiated samples have only diffraction rings from LiF (see FIGS. 9A-9D). Therefore, it is estimated that the oxygen part requires a 72.9% expansion of its original volume in order to form the Li₂O given that the Li radius is 90 pm. In contrast, the Ge part needs another 270% expansion of its original volume to form the Li_{4.4}Ge if the densities of crystalline Ge and Li_{4.4}Ge are taken into account. Overall, based on this calculation, GeOₓ only needs 1.38 times the opening spacing to accommodate volume expansion during a full lithiation. The role of oxygen in the reduction of volume expansion is similar to, for example, that of second metals in alloy anodes (see. e.g., Kepler, 1999 and Mao, 1999), oxygen in conversion electrodes (Poizot, P. et al., Nature 407, 496-499 (2000); incorporated herein by reference in its entirety) and alloy-metal oxides (Idota, Y. et al. Science 276, 1395-1397 (1997); incorporated herein by reference in its entirety).

### Example 11

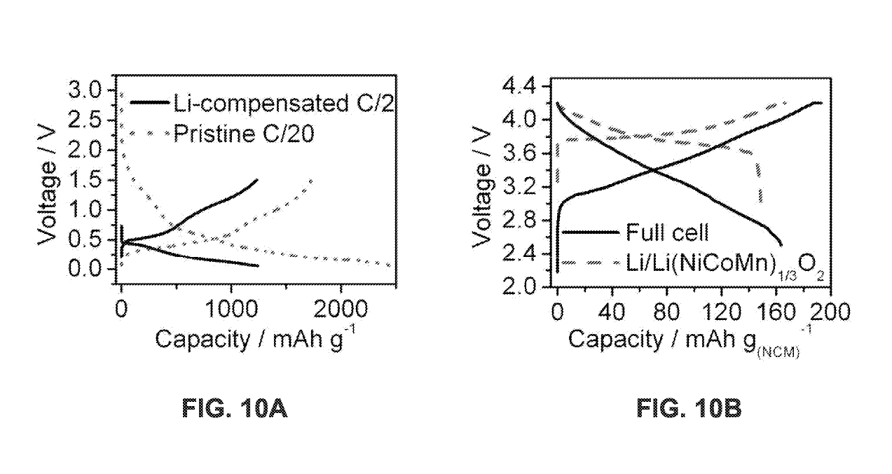

The hurdle of low initial Coulombic efficiency (70%) had to be overcome in order to make a practical high-performance anode. The Li-ion storage systems with high surface areas typically have extensive irreversibility, for example, due to the consumption of Li⁺ for forming SEIs during lithiation (Aurbach, D. et al. Chem. Mater. 14, 4155-4163 (2002); incorporated herein by reference in its entirety). It was possible to overcome this problem by depositing air-stable lithium powder on the anode film (Lectro Max from FMC Lithium). The extra Li-ion source helps to compensate for the generation of lithium consumed by the SEI formation and enhance the electrochemical reversibility of the anode (Li, Y. & Fitch, B. Electrochem. Comm. 13, 664-667 (2011); incorporated herein by reference in its entirety). An initial efficiency of 99.5% with an open-circuit voltage (OCV) of 0.74 V was obtained as shown in FIG. 10A.

### Example 12

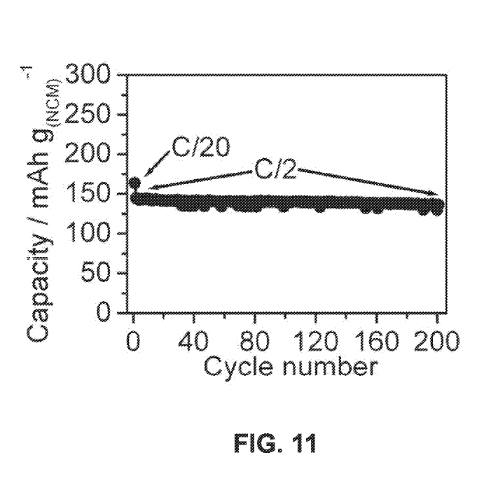

A full cells having Li(NiCoMn)_{1/3}O₂ (NCM) as a cathode and the Li-compensated GeOₓ as an anode were fabricated. The full cells had a discharge capacity of 164 mAh g_{(NCM)}⁻¹ at C/20 (based on Li(NiCoMn)_{1/3}O₂) between 2.5 V and 4.2 V, with an initial Coulombic efficiency of 85% (see FIG. 10B). The voltages were lower and more slanted than voltages in systems with lithium metal used as the anode (i.e., in the half cell). The cells realized a discharge capacity of 144 mAh g_{(NCM)}⁻¹ at the C/2 rate (based on Li(NiCoMn)_{1/3}O₂). Importantly, as shown in FIG. 11, cycling was stable, with an average loss of only 0.028% per cycle over the 200 cycles. The performance shown by this anode is indicative of its excellent reversibility and stability in a full cell.

All publications and patents mentioned in the above specification are herein incorporated by reference in their entireties. Various modifications and variations of the described nanomaterials and methods will be apparent to those skilled in the art without departing from the scope and spirit of the invention. Although the disclosure has been described in connection with specific preferred embodiments, it should be understood that the invention as claimed should not be unduly limited to such specific embodiments. Indeed, those skilled in the art will recognize, or be able to ascertain using the teaching herein and no more than routine experimentation, many equivalents to the specific embodiments of the invention described herein. Such equivalents are intended to be encompassed by the following claims.

1. A composition comprising:
an agglomerate of ultrafine primary particles made from an amorphous germanium oxide compound having a formula (1)
GeOₓ, (1)
wherein x ranges between 0.01 and 1.99.

2. The composition of claim 1, wherein x ranges between about 0.01 and 1.50.

3. The composition of claim 2, wherein x ranges between about 0.1 and 1.00.

4. The composition of claim 3, wherein x is about 0.67.

5. The composition of claim 1, wherein a diameter of the shortest cross-section of the ultrafine primary particles is between 1 nm and 100 nm.

6. The composition of claim 5, wherein a diameter of the shortest cross-section of the ultrafine primary particles is between 1 nm and 10 nm.

7. The composition of claim 5, wherein a diameter of the shortest cross-section of the ultrafine primary particles is about 4 nm.

8. The composition of claim 1, wherein the agglomerate has one or more pores.

9. The composition of claim 8, wherein the one or more pores has a diameter between about 0.1 nm and about 20 nm.

10. The composition of claim 9, wherein the surface area of the one or more pores is between 10 m² g⁻¹ and 2000 m² g⁻¹

11. The composition of claim 10, wherein the total volume of the one or more pores is between 0.01 cm³ g⁻¹ and 10 cm³ g⁻¹.

12. The composition of claim 1, further comprising alkali metals, transition metals, non-metals, or halogens.

13. An electrode comprising
a germanium oxide composition;
a conductive additive; and
a binder,
wherein the germanium oxide composition comprises: an agglomerate of ultrafine primary particles made from an amorphous germanium oxide compound having a formula (1)
GeOₓ, (1)
wherein x ranges between 0.01 and 1.99.

14. The electrode of claim 13, wherein x ranges between about 0.01 and 1.50.

15. The electrode of claim 14, wherein x ranges between about 0.1 and 1.00.

16. The electrode of claim 15, wherein x is about 0.67.

17. The electrode of claim 13, wherein a diameter of the shortest cross-section in the ultrafine primary particles is between 1 nm and 100 nm.

18. The electrode of claim 13, wherein the agglomerate has one or more pores having a diameter between about 0.1 nm and about 20 nm.

19. The electrode of claim 13, wherein the electrode is an anode operable in a lithium ion battery environment.

20. An electrochemical cell comprising:
a cathode,
an anode, and
an electrolyte solution,
wherein the anode comprises an agglomerate of ultrafine primary particles made from an amorphous germanium oxide compound having a formula (1)
GeOₓ, (1)
wherein x ranges between 0.01 and 1.99.

21. The electrochemical cell of claim 20, wherein x ranges between about 0.01 and 1.50.

22. The electrochemical cell of claim 21, wherein x ranges between about 0.1 and 1.00.

23. The electrochemical cell of claim 22, wherein x is about 0.67.

24. The electrochemical cell of claim 20, wherein the agglomerate has one or more pores having a diameter between about 0.1 nm and about 20 nm.
